(19) United States
(12) Patent Application Publication
(10) Pub. No.: US 2026/0310515 A1
(43) Pub. Date: Oct. 8, 2026

(54) COMPUTING SYSTEM UTILIZING SHARED RESOURCES

(71) Applicant: Hewlett Packard Enterprise Development LP, Spring, TX (US)

(72) Inventors: Vinay Babu Gavirangaswamy, Milpitas, CA (US); Barbara Mary Chapman, Miller Place, NY (US); Soumitra Chatterjee, Bangalore (IN); David Christopher Gloe, Bloomington, MN (US); James Harold Nordby, Bloomington, MN (US); Alok Mishra, Edison, NJ (US); Gourav Rattihalli, Milpitas, CA (US); Xin Zhan, Houston, TX (US)

(21) Appl. No.: 19/235,111

(22) Filed: Jun. 11, 2025

(30) Foreign Application Priority Data
Apr. 2, 2025 (IN) 202511032822

(51) Int. Cl. G06F 9/50

(52) U.S. Cl. CPC G06F 9/5044; G06F 9/5033; G06F 9/5038

(57) ABSTRACT

Implementation disclosed herein include a computing system that includes computing nodes with central processing units and accelerators. A workload manager can be programmed to receive information related to a plurality of applications. Each application is segmented into executable tasks based on target processor types and each executable task is associated with resource requirement data. Compute cycle slot availability of the accelerator is tracked during execution of an executable task of a first application. Available compute cycle slots of the accelerator are identified based the resource requirement data the executable task of the first application and allocated to executable tasks of a second application while maintaining execution of the first application so that tasks of the second application can be executed during the available compute cycle slots.

### CROSS-REFERENCE TO RELATED APPLICATIONS

### Background

High-performance computing (HPC) systems have evolved from traditional CPU-based architectures to complex heterogeneous environments incorporating various specialized accelerators. HPC systems typically include central processing units (CPUs) working alongside accelerators such as graphics processing units (GPUs), field-programmable gate arrays (FPGAs), and quantum processing units (QPUs). Each of these specialized computing resources offers unique capabilities for specific types of computational workloads, with GPUs excelling at parallel processing tasks, FPGAs providing customizable hardware acceleration, and QPUs handling quantum algorithms.

Resource allocation in HPC environments is managed by workload managers that schedule applications across available computing nodes. These workload managers are responsible for distributing computational tasks across the system's resources. They typically maintain job queues where applications wait until appropriate resources become available, then allocate nodes to applications based on their specified resource requirements and scheduling policies that may consider factors like job priority and resource availability.

### BRIEF DESCRIPTION OF THE DRAWINGS

For a more complete understanding of this disclosure, and advantages thereof, reference is now made to the following descriptions taken in conjunction with the accompanying drawings, in which:

FIG. 1 illustrates a high-level architecture of a heterogeneous computing system in accordance with one or more embodiments.

FIG. 2 illustrates a more detailed view of a heterogeneous computing network in accordance with one or more implementations.

FIG. 3A illustrates a block diagram of implementation of a workload manager in accordance with an example implementation.

FIG. 3B illustrates a block diagram of implementation of a compiler in accordance with an example implementation.

FIG. 4 illustrates a system architecture for an optimized workload management implementation in accordance with an example implementation.

FIG. 5 illustrates a timing diagram depicting the flow of information and control between components during job execution in accordance with an example implementation.

FIGS. 6A and 6B illustrate tables of constraints for an algorithm for optimized workload management.

FIG. 7 illustrates a flow chart depicting the process flow for optimized workload management in heterogeneous computing environments in accordance with a more specific example implementation.

FIG. 8 illustrates a flow chart of a computer-implemented method for analyzing and segmenting applications for efficient resource allocation in accordance with an example implementation.

FIG. 9 illustrates a flow chart of a computer-implemented method for allocating and sharing accelerator resources between applications in accordance with an example implementation.

FIG. 10A illustrates a heterogeneous computing environment comprising three compute nodes to illustrate operation of example implementations.

FIGS. 10B, 10C, and 10D illustrates jobs comprising CPU and GPU tasks for execution on the compute nodes of FIG. 10A.

FIG. 11A illustrates a timing diagram of resource allocation and job execution without resource sharing.

FIG. 11B illustrates a timing diagram of optimized resource allocation with accelerator sharing across multiple jobs.

FIG. 12 illustrates an experimental setup used to verify benefits of an implementation in a high-performance computing environment.

FIGS. 13A and 13B illustrates experimental results comparing non-sharing and resource-sharing approaches to allocating resource.

### DESCRIPTION

Implementations of the invention address resource underutilization in modern high-performance computing (HPC) systems that incorporate various accelerators (e.g., GPUs, FPGAs, QPUs). Current workload managers schedule applications by dedicating entire nodes with specialized resources for allotted periods, which can lead to inefficiency when applications do not fully utilize these resources, either because the node has excess resources or because applications use resources in bursts rather than uniformly.

In one implementation, a scheduling algorithm can integrate compile-time and runtime data generated during the application's development processes. By segmenting applications into smaller executable tasks based on target processor types, the scheduler can assess resource usage more precisely. This segmentation allows for the identification of idle compute cycles within accelerators, enabling those cycles to be allocated to other applications in need of resources, effectively reducing queue wait times and improving system throughput.

This approach to task scheduling can utilize a hybrid scheduling technique that maximizes accelerator utilization while ensuring fairness in resource distribution among applications. This technique can include evaluating runtime complexity and resource utilization metrics for each task, and creating metadata accessible to workload managers to better schedule tasks across heterogeneous environments.

The system bridges compilers and workload managers by analyzing source code to identify portions that utilize different types of computing resources. The application is segmented into executable tasks based on target processor types (CPU, GPU, etc.), and for each task, the system evaluates runtime complexity and predicted resource utilization patterns. This metadata is generated and packaged with the executable tasks in a format accessible to the workload manager, which uses it to make intelligent scheduling decisions.

For example, a scheduling approach can be implemented where resources on nodes can be shared among applications from different users across runtime slots. In various implementations, a workload manager maintains a resource availability matrix that tracks the availability of compute cycle slots for accelerators across multiple time periods. When a primary application isn't fully utilizing an accelerator, the system can allocate those available compute cycle slots to a second application without affecting the efficiency of either application. The system can also consider data transfer costs associated with using non-local accelerators, only proceeding when the benefits exceed these costs.

Use of various implementations can lead to reduction in job wait time and a decrease in execution times compared to traditional scheduling methods. Better resource allocation can be achieved by enabling shared use of accelerators across different applications while maintaining overall system efficiency and performance. Furthermore, the design can be implemented in a manner compatible with various existing workload management systems allowing for seamless integration into current HPC frameworks so that benefits can be achieved without requiring significant changes to existing infrastructure.

In the following description, inventive aspects are described primarily in the context of high-performance computing systems with specialized accelerators like GPUs, FPGAs, and QPUs. It should also be appreciated, however, that the concepts disclosed here can apply in other contexts. For example, cloud computing environments, edge computing systems, and data centers can benefit from the teachings. Aspects of this disclosure may similarly apply to virtualized computing environments where multiple virtual machines or containers share physical hardware resources, machine learning training clusters where specialized hardware accelerators are in high demand, and enterprise computing environments where efficient resource utilization can significantly reduce operational costs, as just a few examples.

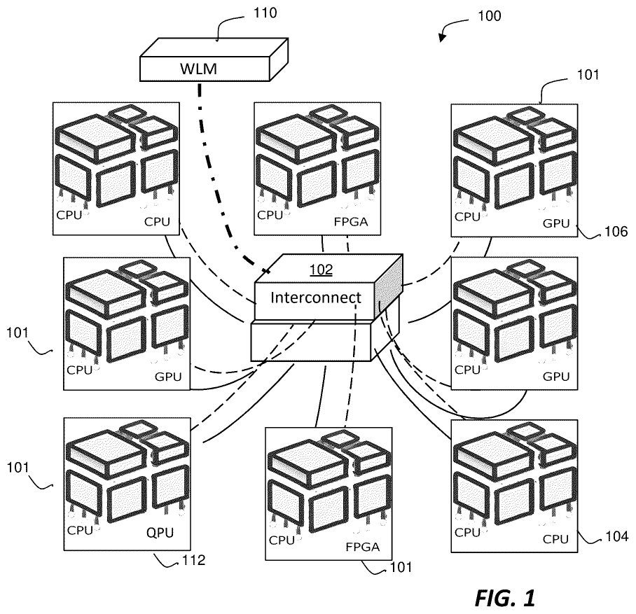

FIG. 1 illustrates a high-level architecture of a heterogeneous computing system 100 in accordance with one or more embodiments. The heterogeneous computing system 100 includes an interconnect 102 that couples multiple computing nodes 101 together. In an embodiment, the interconnect 102 enables high-speed data transfer between the computing nodes 101, allowing for efficient communication and resource sharing across the system. The computing nodes 101 have different configurations of processing resources.

In the illustrated example, each computing node includes at least a central processing unit (CPU) 104, and some nodes are equipped with additional accelerators. In various embodiments, these accelerators may include graphics processing units (GPUs) 106, quantum processing units (QPUs) 108, or field-programmable gate arrays (FPGAs) 112. Other computing nodes (not shown in FIG. 1) could include only a CPU 104. Any of the computing nodes can include more than one of the CPUs and accelerators, including different types of accelerators in the same computing node.

The heterogeneous nature of the system allows different types of computational tasks to be executed on the most appropriate hardware, potentially improving overall system performance and efficiency. The interconnect 102 enables applications running on one node to utilize accelerator resources available on other nodes when those resources are not fully utilized by their local applications.

FIG. 1 also shows a workload manager (WLM) 110 connected to the interconnect 102. In various implementations, the workload manager 110 is responsible for scheduling applications across the computing nodes 101 and managing resource allocation throughout the system 100. The workload manager 110 maintains information about the availability and capabilities of each computing node, including details about their CPUs 104 and any accelerators such as GPUs 106 or QPUs 108. In various embodiments, the workload manager 110 receives applications that have been segmented into executable tasks based on target processor types and tracks compute cycle slot availability across all nodes in the system. By monitoring resource utilization, the workload manager 110 can identify available compute cycle slots on accelerators during execution of applications and allocate these available slots to other waiting applications, thereby improving overall system efficiency and throughput.

Operation of the workload manager 110 will be discussed in greater detail below.

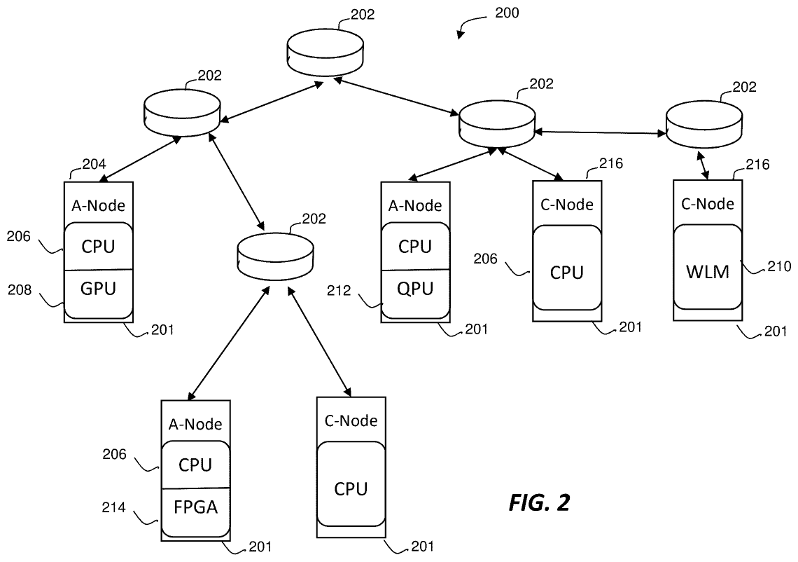

FIG. 2 illustrates a more detailed view of a heterogeneous computing network 200 in accordance with one or more implementations. The network 200 includes a plurality of computing nodes 201 interconnected through multiple network switches 202 arranged in a hierarchical topology. The network switches 202 facilitate communication between the various nodes in the system 200. In an embodiment, these switches 202 may be high-performance network switches designed specifically for HPC environments, providing low-latency, high-bandwidth connections between nodes.

The computing nodes 201 in network 200 are categorized into different types based on their hardware configuration. Accelerator nodes 204 can contain different combinations of processing resources. As shown in the figure, some accelerator nodes 204, indicated as A-Nodes, include both a CPU 206 and an accelerator such as GPU 208. In other illustrated examples, accelerator nodes can include a CPU 206 and a QPU 212, and yet others include a CPU 206 and an FPGA 214.

In addition to the GPUs, FPGAs, and QPUs shown in the figures, other types of accelerators can be included in systems 100 and 200. As examples, digital signal processors (DSPs) are specialized for processing signals and streaming data, application-specific integrated circuits (ASICs) are designed for specific computational tasks like machine learning or cryptography, data processing units (DPUs) can offload networking and storage functions from the CPU, AI accelerators can be specifically optimized for neural network operations and deep learning workloads, and tensor processing units (TPUs) can be designed specifically for machine learning applications. In various embodiments, the heterogeneous computing system may incorporate any combination of these accelerator types to address different computational workloads efficiently.

Compute nodes, indicated as C-Nodes, 216 represent computing nodes that contain a CPU 206 resources without additional accelerators. A compute node 216 can include multiple CPUs. In the example of FIG. 2, one of the compute nodes 216 executes the workload manager 210. It is understood that the workload manager 210 can operate on a single compute node as illustrated or be distributed among multiple compute nodes.

As noted above, the role of the workload manager 210 is to allocate resource among different applications that are being concurrently. The conventional approach to resource allocation can create inefficiencies, for example, when the number of resources on a node exceeds what an application needs and when applications use compute resources in bursts rather than continuously, leaving resources idle during certain periods. These inefficiencies can be problematic given the scarcity and cost of specialized accelerators.

Implementations can address these issue by providing a bridge between compilers and workload managers that enables more efficient sharing of accelerator resources. The compiler segments applications into executable tasks based on the target processor types (CPU, GPU, etc.) and evaluates the runtime complexity of each task. This information is then provided to the workload manager, which uses it to identify available compute cycle slots on accelerators and allocate them to other applications, effectively allowing multiple applications to share the same accelerator without affecting performance.

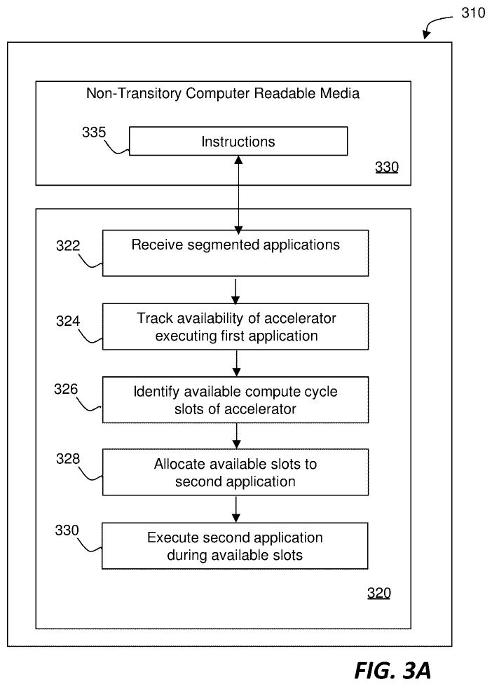

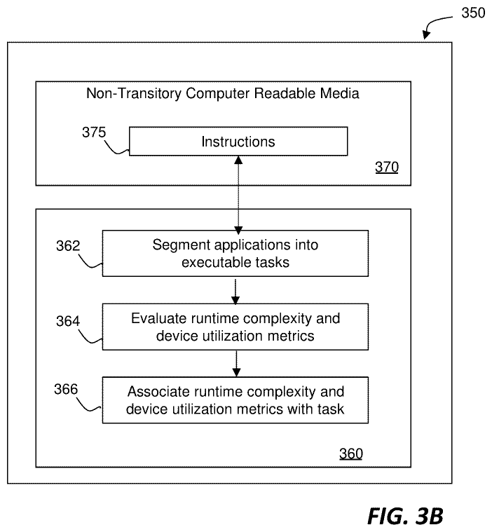

FIG. 3A provides an example of one implementation of a workload manager 310 and can be used in conjunction with the systems illustrated in FIGS. 1 and 2, which each illustrate a plurality of computing nodes 101, 201 and a workload manager 110, 210. The workload manager 310 of FIG. 3 includes one or more processors 320 and memory 330 storing program code (instructions) 335 that, when executed by the one or more processors 320, causes the one or more processors 320 to perform a series of operations. In an implementation, the workload manager 310 may be implemented as a distributed system with components running on multiple physical machines to provide fault tolerance and scalability.

In operation 322, information related to a number of applications is received. Each application has been segmented into executable tasks based on target processor types and each executable task is associated with resource requirement data. As will be discussed below, the segmentation can be performed when the application is compiled and the information stored in metadata associated with the application. In various implementations, this metadata may be embedded in a non-executable section of application binaries, such as the “notes” section in ELF (Executable and Linkable Format) binaries, making it accessible to the workload manager without modifying existing application interfaces.

The workload manager 310 will track compute cycle slot availability of accelerators associated with the computing nodes as indicated by operation 324. As discussed above, the accelerators can be graphics processing units, field-programmable gate arrays, quantum processing units, or other types of circuits. For example, the workload manager can track compute cycle slot availability of a particular accelerator during execution of an executable task of a first application. In one or more implementations, this tracking involves maintaining a resource availability matrix that records the availability of accelerator slots on each machine for each time slot, which is updated dynamically as jobs are scheduled and resources are freed.

In operation 326, the workload manager can identify available compute cycle slots of the particular accelerator based on the resource requirement data of the executable task of the first application. The available compute cycle slots can then be allocated to executable tasks of a second application while maintaining execution of the first application as noted in operation 328. In this manner, the executable tasks of the second application can be executed during the available compute cycle slots without adversely affecting execution of the first application (operation 330). For example, the accelerator can include multiple processing cores capable of executing different tasks simultaneously. In an implementation, this identification process involves analyzing predicted resource utilization patterns included in the resource requirement data to determine time periods when the accelerator is not being fully utilized.

The workload manager can assign executable tasks of the first application and the second application to different processing cores of the accelerator to enable parallel execution. In a system that includes heterogeneous accelerators of different types across the plurality of computing nodes, the workload manager can match executable tasks to specific accelerator types based on hardware compatibility information included in the resource requirement data of each application. In various implementations, the workload manager may also consider the computational complexity of each task to ensure that shared resources are allocated in a manner that maintains performance guarantees for all applications.

As noted, the segmentation can be implemented by a compiler, an example of which is shown in FIG. 3B. In this example, the compiler is implemented as a computing device 350 that includes one or more processors 360 and memory 370 storing compiler program code or instructions 375. The compiler can be operated on one or more computers included in the network or separate from the network. The applications are segmented into pluralities of executable tasks based on target processor types during compilation (operation 362). Runtime complexity and device utilization metrics are evaluated for each executable task (operation 364) and, for each executable task, the runtime complexity and device utilization metrics are associated with that task (operation 366). In one or more implementations, the runtime complexity may be expressed as computational order of complexity (e.g., O(n²), O(n log n)), while utilization metrics might include statistical distributions of expected resource usage over time, such as Poisson, uniform, or Gaussian distributions.

As discussed with respect to FIG. 1, the system can include a dedicated high-speed interconnect between the computing nodes to enable data transfer between a node executing the first application and a node executing the second application. When performing the allocation, the workload manager can consider interconnect bandwidth and latency. In an implementation, the workload manager calculates data transfer costs associated with allocating available compute cycle slots to applications on remote nodes, including the time required to move data to the accelerator and retrieve results, and only proceeds with the allocation when the benefits of utilizing the available compute cycle slots exceed these data transfer costs.

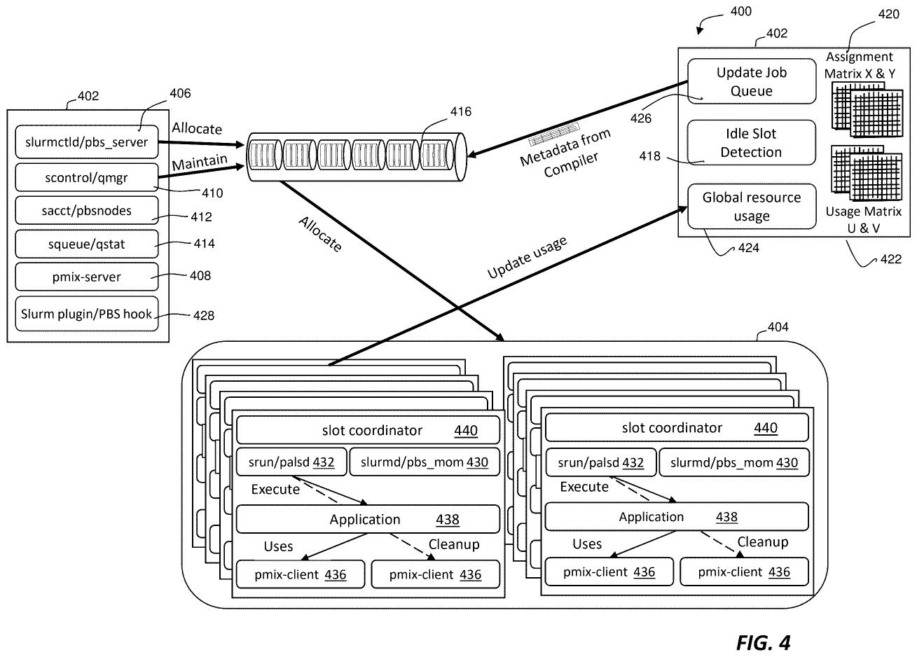

FIG. 4 illustrates a detailed system architecture 400 for an optimized workload management implementation in accordance an example implementation. The architecture 400 expands upon systems shown in previous figures, providing a more granular view of the components involved in resource sharing across heterogeneous computing environments to provide a specific, non-limiting example.

The system architecture 400 includes management nodes 402 that host workload management services and compute nodes 404 that execute applications. The management nodes 402 include several interconnected components that work together to enable efficient resource allocation and scheduling.

In this particular implementation, the management nodes 402 in the heterogeneous computing system 400 incorporate a Slurm workload manager 406 (slurmctld/pbs_server), which functions as a highly scalable, fault-tolerant resource management and job scheduling system designed specifically for high-performance computing environments. Slurm, which stands for Simple Linux Utility for Resource Management, provides comprehensive functionality for allocating compute resources to users' jobs, monitoring and managing job execution across distributed computing nodes 404, and optimizing system utilization through sophisticated scheduling algorithms. In this implementation, the Slurm architecture incorporates specialized components that enable fine-grained tracking and sharing of accelerator resources. The management nodes 402 host the central Slurm controller (slurmctld) along with supporting services that collectively maintain the global system state, process job submissions, make scheduling decisions, and coordinate with agents running on compute nodes 404 to efficiently execute applications across the available resources.

It is understood that the Slurm implementation is provided only as an example. The invention is not so limited and can be implemented in other environments. For example, PBS Professional (Portable Batch System) represents another option for use in HPC environments, featuring a comprehensive suite including the pbs_server, pbs_mom, and pbs_sched components that provide job scheduling, resource management, and policy enforcement capabilities. As discussed below, features of the PBS suite can be incorporated in the specific example.

Another alternative is IBM Spectrum LSF (Load Sharing Facility), which provides advanced scheduling policies and support for diverse computing environments, from clusters to cloud infrastructures. The open-source HTCondor system excels in managing distributed computing resources across heterogeneous environments, particularly for high-throughput computing workloads. For cloud-native applications, Kubernetes with GPU extensions provides container orchestration with support for accelerator resources. Apache Mesos delivers a distributed systems kernel that abstracts CPU, memory, storage, and computing resources. Other options include Flux Framework, a next-generation resource manager designed specifically for exascale computing environments, and Ray, which specializes in distributed computing for AI and machine learning workloads. Each of these workload managers can be integrated with the idle slot detection and slot coordinator components through appropriate plugins or hooks to enable the accelerator resource sharing capabilities described in this disclosure.

In the illustrated example, the management nodes 402 includes the workload manager server 406 (slurmctld/pbs_server) which serves as the central controller for resource allocation decisions. This component 406 maintains the global state of the computing environment and makes high-level scheduling decisions. The workload manager server 406 interfaces with several supporting services, including communication management component 408 (pmix-servers) that facilitate process management and inter-process communication across the distributed system.

Administrative component 410 (control/qmgr) provides administrative interfaces for system configuration and policy management. System administrators can define scheduling policies, resource allocation rules, and job priorities through this interface 410. Accounting component 412 (sacct/pbsnodes) maintains detailed accounting information about resource utilization and node status, while queue management component 414 (squeue/qstat) manages the job queue 416 and provides status information about pending and running jobs.

The architecture 400 also includes specialized components for optimizing resource utilization. The idle slot detection component 418 continuously monitors accelerator usage patterns to identify underutilized compute cycle slots. This component 418 analyzes real-time resource utilization data to detect periods when accelerators like GPUs, FPGAs, or QPUs are not being fully utilized by their primary applications.

The system maintains several data structures to track resource allocation and availability. The assignment matrix X & Y 420 records which applications are assigned to which resources at specific time slots, while the usage matrix U & V 422 tracks the actual utilization of these resources over time. Together, these matrices 420, 422 provide a comprehensive view of the system's resource allocation state and enable the workload manager 406 to make informed scheduling decisions as will be discussed in greater detail below.

Global resource usage component 424 aggregates utilization data from across the system, providing a holistic view of resource availability that spans multiple computing nodes 404. This global perspective enables the workload manager 406 to identify opportunities for resource sharing that might not be apparent when looking at individual nodes in isolation.

Update job queue component 426 dynamically adjusts job requirements based on resource availability. When idle accelerator slots are detected, this component 426 can modify job specifications to utilize these available resources, potentially reducing wait times for applications in the queue 416.

Slurm plugin/pbS hook component 428 provides integration points with existing workload management systems. These plugins and hooks 428 allow the optimized scheduling approach to be implemented without requiring wholesale replacement of existing infrastructure, making adoption more practical in production environments.

The compute nodes 404 execute the actual applications and include several components that work together to manage local resources. Each compute node 404 runs a workload manager agent 430 (slurmd/pbs_mom) that communicates with the central workload manager server 406 and executes local resource management functions.

The application launcher 432 (srun/palsd) is responsible for starting applications on the compute node 404, setting up the execution environment, and managing the application lifecycle. The component 434 (atomd) handles atomic operations and synchronization between processes, while the component 436 (pmix-client) facilitates communication between the application 438 and the workload management infrastructure.

The architecture 400 also includes a slot coordinator component 440 for each compute node 404. This component 440 monitors local resource utilization in real-time and coordinates with the central workload manager 406 to identify opportunities for sharing accelerator resources. When an application 438 is not fully utilizing an accelerator, the slot coordinator 440 signals this information to the workload manager 406, enabling other applications to use the idle compute cycles.

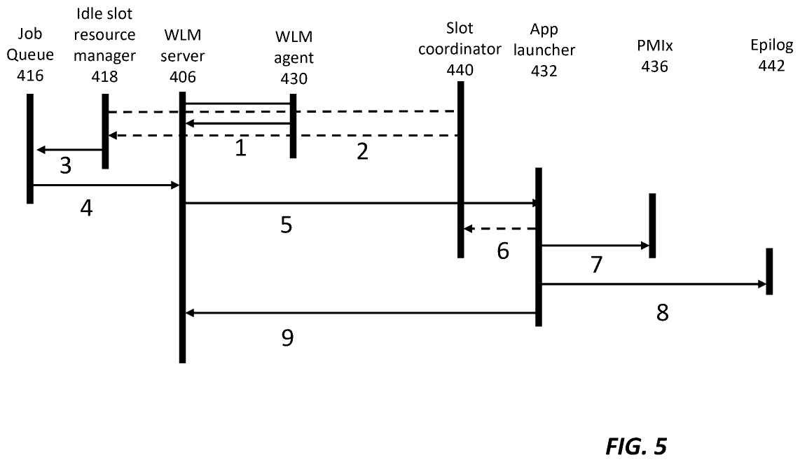

Operation of an example implementation using the architecture 400 of FIG. 4 can be described by a sequence of events illustrated in the timing diagram of FIG. 5, which depicts the flow of information and control between components during job execution. The process begins with a periodic communication between the workload manager server 406 and the workload manager agent 430 (arrow 1 in FIG. 5), during which they exchange information about node availability and resource status. This communication ensures that the central workload manager server 406 maintains an up-to-date view of the entire system's resources.

Concurrently, the slot coordinator 440 on each compute node 404 continuously monitors resource utilization and updates the usage matrix U & V 422 (arrow 2) to reflect the current usage patterns of accelerators and other computing resources. This real-time monitoring enables the system to identify periods when accelerators are not being fully utilized by their primary applications.

The idle slot resource manager 418 analyzes this utilization data and updates the job's CPU and GPU requirements based on the availability of idle slots (arrow 3). It then updates the Assignment Matrix X & Y 420 to reflect potential resource sharing opportunities. This analysis considers factors such as the runtime complexity and predicted resource utilization patterns associated with each executable task.

When scheduling decisions need to be made, the workload manager server 406 selects a job from the job queue 416 based on priority, node availability, and slot availability information provided by the idle slot resource manager 418 (arrow 4). Unlike traditional scheduling approaches that allocate entire nodes to applications, this enhanced system can allocate specific time slots on accelerators to different applications, enabling more efficient resource utilization.

After selecting a job, the workload manager server 406 assigns nodes to launch the job (arrow 5). This assignment includes information about which specific accelerator resources should be used and during which time slots these resources will be available to the application.

Before execution begins, the application launcher 432 consults with the slot coordinator 440 (arrow 6) to determine which node and time slot to use for each part of the application. This consultation ensures that the application's executable tasks are matched with appropriate resources based on their specific requirements and the current system state.

Once the resources have been identified, the application launcher 432 uses the process management interface (PMIx) 436 to perform pre-run initializations for processes, memory allocation, and other setup tasks (arrow 7). These initializations prepare the execution environment for the application so that it has access to the resources it needs during the allocated time slots.

After the job completes, the launcher 432 calls the epilog component 442 for cleanup operations (arrow 8), releasing any temporary resources and performing necessary post-execution tasks. Finally, the system returns results to the user and releases the allocated nodes and resources (arrow 9), making them available for other applications in the queue.

An algorithm for performing the operations described herein will now be described. Various parameters and scheduling constraints will be considered to use a non-local accelerator effectively. The workload managers have prior knowledge about the application's resource requirements. In this example, applications are scheduled to use CPU and GPU accelerators where compute cycle slots on machines are allocated to applications. The following variables are identified to help describe the problem and solution.
A: Set of applications, indexed by a
Jₐ: Ordered set of tasks belonging to application a, indexed by j.
M: Set of machines, indexed by m.
Kₘ: Number of CPUs on machine m, indexed by c (e.g., c∈{1, . . . , Kₘ}).
Gₘ: Number of GPUs on machine m, indexed by g (e.g., g∈{1, . . . , Gₘ}).
S: Total number of compute cycle slots available for scheduling.

$${P}_{j}^{CPU} :$$

Number of GPU cycle slots required by task j.

$${P}_{j}^{GPU} :$$

Number of GPU cycle slots required by task j.
Rⱼ: Release time of task j.
Dⱼ: Deadline for task j.
Tⱼ: Type of task j (Tⱼ∈{CPU, GPU, Both}).
Mₐ: Set of machines assigned to application a. ∃Mₐ⊆M ∀ a∈A. It is assumed that the total number of machines requested by all jobs Mₐ≤M.
α_{jmm′}: Data transfer cost to move data from the source machine m to the destination machine m′.
β_{jmm′}: Data transfer cost to move results back from the destination machine m′ to the source machine m.

The algorithms use following variables to check eligibility and decide task allocation to local or non-local accelerator.
Sⱼ: Start time slot of task j.
Cⱼ: Completion time slot of task j.

The start time for a task should be before its completion time Sⱼ₊₁≥Cⱼ ∀ a∈A, ∀ j, j+1∈Jₐ. Also, the release time slot of a task should be greater than Sⱼ≤Rⱼ ∀ a∈A, ∀ j∈Jₐ. Any given task's completion time slot should be earlier than its deadline Cⱼ≤Dⱼ ∀ a∈A, ∀ j∈Jₐ.
x_{jmc}(t): Binary variable, where x_{jmc}(t)=1 if job j is assigned to CPU c on machine m at time slot t, and x_{jmc}(t)=0 otherwise.
y_{jmg}(t): Binary variable, where y_{jmg}(t)=1 if job j is assigned to GPU g on machine m at time slot t, and y_{jmg}(t)=0 otherwise.

The sum of all CPU and GPU slots assigned to application should be in accordance with the total slots required by the application and total machine capacity.

$${\sum }_{m ∈ {M}_{a}} {\sum }_{c = 1}^{{C}_{m}} {\sum }_{t = {S}_{j}}^{{C}_{j}} {x}_{jmc} ( t ) - {P}_{j}^{CPU} ∀ a ∈ A , j ∈ {J}_{a}$$

$${\sum }_{m ∈ {M}_{a}} {\sum }_{g = 1}^{{G}_{m}} {\sum }_{t = {S}_{j}}^{{C}_{j}} {y}_{jmc} ( t ) - {P}_{j}^{GPU} ∀ a ∈ A , j ∈ {J}_{a}$$

u_{mc}(t): Binary variable, where u_{mc}(t)=1 if CPU c on machine m is used at time slot t, and u_{mc}(t)=0 otherwise.
v_{mg}(t): Binary variable, where v_{mg}(t)=1 if GPU g on machine m is used at time slot t, and v_{mg}(t)=0 otherwise.

Values of the variable x_{jmc}, y_{jmg}, u_{mc}, and v_{mg} is assigned as below:
x_{jmc}(t)∈{0, 1} ∀ (a∈A, j∈Jₐ, m∈Mₐ, c=1, . . . , Kₘ, t)
y_{jmg}(t)∈{0, 1} ∀ (a∈A, j∈Jₐ, m∈Mₐ, g=1, . . . , Gₘ, t)
u_{mc}(t)∈{0, 1} ∀ (m∈Mₐ, c=1, . . . , Kₘ, t)
v_{mg}(t)∈{0, 1} ∀ (m∈Mₐ, g=1, . . . , Gₘ, t) constrained by
u_{mc}(t)=Σ_{j∈J}_{ₐ} x_{jmc}(t) ∀ (m & Mₐ, c=1, . . . , Kₘ, t) v_{mg}(t)=Σ_{j∈J}_{ₐ} y_{jmg}(t) ∀ (m & Mₐ, g=1, . . . , Gₘ, t)

$${C}_{j}^{CPU} :$$

Completion time slot for CPU execution of task j.

$${C}_{j}^{GPU} :$$

Completion time slot for GPU execution of task j.

$${C}_{j}^{Both} :$$

Completion time slot for task that use both CPU and GPU.

It is noted that αⱼₘₘ, and βⱼₘₘ, is further reduced by assigning machines closer to applications that will share compute cycles.

Values of the variable x_{jmc}, y_{jmg}, u_{mc}, and v_{mg} is assigned as below
x_{jmc}(t)∈{0, 1} ∀ (a∈A, j∈Jₐ, m∈Mₐ, c=1, . . . , Kₘ, t)
y_{jmg}(t)∈{0, 1} ∀ (a∈A, j∈Jₐ, m∈Mₐ, g=1, . . . , Gₘ, t)
u_{mc}(t)∈{0, 1} ∀ (m∈Mₐ, c=1, . . . , Kₘ, t)
v_{mg}(t)∈{0, 1} ∀ (m∈Mₐ, g=1, . . . , Gₘ, t) constrained by
u_{mc}(t)=Σ_{j∈J}_{ₐ}x_{jmc}(t) ∀ (m∈Mₐ, c=1, . . . , Kₘ, t)
v_{mg}(t)=Σ_{j∈J}_{ₐ}y_{jmg}(t) ∀ (m & Mₐ, g=1, . . . , Gₘ, t)

$${C}_{j}^{CPU} :$$

Completion time slot for CPU execution of task j.

$${C}_{j}^{GPU} :$$

Completion time slot for GPU execution of task j.

$${C}_{j}^{Both} :$$

Completion time slot for task that use both CPU and GPU.

It is noted that αⱼₘₘ, and βⱼₘₘ, is further reduced by assigning machines closer to applications that will share compute cycles.

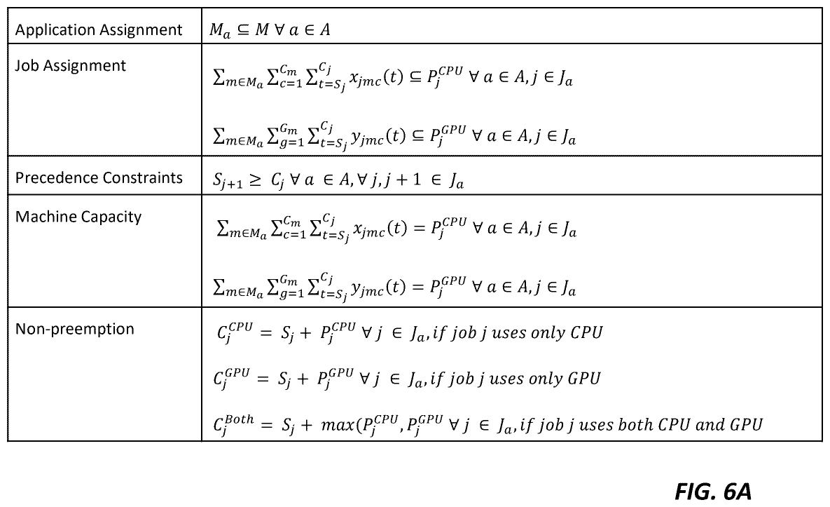

Constraints placed upon the algorithm are shown in FIGS. 6A and 6B. Here the application assignment is designated as Mₐ⊆M ∀ a∈A and the job assignment is shown in the table of FIG. 6A. The constraints being considered include precedence constraints, machine capacity, non-preemption, release time, deadline, binary variable constraints, resource usage tracking and exclusive resource usage.

The total time required to execute all jobs is determined by the completion time of the last job in the application with the longest execution time:

$${TT}_{idlenon - sharing} = \begin{matrix}max \\ j ∈ {J}_{a} , a ∈ A ( {C}_{j} )\end{matrix}$$

Launching of the application in the job queue among idle GPU cycles will now be described. Global resource tracking can be implemented using a resource availability matrix and idle GPU slot detection. The resource availability matrix maintains a global matrix or table that records the availability of GPU slots on each machine for each time slot. This GPU compute cycle availability matrix can be updated dynamically as jobs are scheduled and resources are freed. For idle GPU slot detection, as jobs are executed, the completion of GPU cycles within the allocated CPU duration can be tracked for jobs that use both CPU and GPU. The resource availability matrix can then be updated to mark these GPU slots as available for other applications.

To implement the resource sharing, non-preemption can be relaxed for both the CPUs and GPUs. This relaxation of non-preemption in a traditional HPC node (for both CPU and GPU) can be indicated as

$${C}_{j}^{CPU} = {S}_{j} + {P}_{j}^{CPU} + {α}_{jmm ′} + {β}_{jmm ′} ∀ j ∈ {J}_{a} , if job j uses only CPU$$

$${C}_{j}^{GPU} = {S}_{j} + {P}_{j}^{GPU} + {α}_{jmm ′} + {β}_{jmm ′} ∀ j ∈ {J}_{a} , if job j uses only GPU$$

$${C}_{j}^{Both} = {S}_{j} + max ( {P}_{j}^{CPU} , {P}_{j}^{GPU} ) + {α}_{jmm ′} + {β}_{jmm ′}$$

∀ j∈Jₐ, if job j uses both CPU and GPU

The exclusive resource usage can be relaxed as shown by:

$$∀ ( {x}_{{j}_{i} {mc}_{1}} ( {t}_{1} ) , {y}_{{j}_{i} {mg}_{1}} ( {t}_{1} ) ) and ( {x}_{{j}_{i + 1} {mc}_{2}} ( {t}_{2} ) , {y}_{{j}_{i + 1} {mg}_{1}} ( {t}_{2} ) ) ,$$

$${t}_{1} = {t}_{2} and ( {j}_{i} , {j}_{i + 1} ) ∉ {J}_{a}$$

This constraint allows GPU slots to be used by other jobs from different applications during idle GPU cycles, ensuring efficient resource utilization and is tracked by

$${\sum }_{j ∈ {J}_{a}} {y}_{jmg} ( t ) + {\sum }_{{j}^{′} ∈ {J}_{b} , b \neq a} {y}_{j ′ mg} ( t ) \leq 1 ∀ ( m ∈ M , g = 1 , … , {G}_{m} , t )$$

To calculate the total compute cycles required by an application, compute cycles of all jobs within the application can be summed up, including transfer costs for jobs using remote GPUs.

$$Total Compute Cycles for Application a = {\sum }_{j ∈ {J}_{a}} ( {P}_{j}^{CPU} + {\sum }_{{m , m ′}_{m \neq m ′}} ( {α}_{jmm ′} + {β}_{jmm ′} ) )$$

Here, αⱼₘₘ, and βⱼₘₘ, are included only for jobs that use GPU resources on machines m′ different from their original machine m.

The total time required to execute all jobs in the application with the longest execution time is determined by the maximum of the completion times of all jobs within that application.

$${TT}_{idlesharing} = \begin{matrix}max \\ j ∈ {J}_{a} , a ∈ A\end{matrix} ( max ( {C}_{j}^{CPU} , {C}_{j}^{GPU} , {C}_{j}^{Both} ) )$$

For relaxed non-preemption, this constraint allows GPU slots to be preempted and reused by other jobs when a job using both CPU and GPU has its GPU requirement completed before its CPU requirement. The CPU will continue to be used by the original job, while the GPU slot can be freed for use by other jobs. Below it is shown that

$${TT}_{idlenon - sharing} = \begin{matrix}max \\ j ∈ {J}_{a} , a ∈ A ( {C}_{j} )\end{matrix}$$

Inter-application GPU sharing can be implemented. This constraint allows GPU slots to be used by other jobs from different applications during idle GPU cycles, ensuring efficient resource utilization

$${TT}_{iidlenon - sharing} > {TT}_{idlesharing}$$

This approach allows for better utilization of GPU resources by enabling shared usage across different applications when the primary job's GPU needs are fulfilled before its CPU cycle is complete.

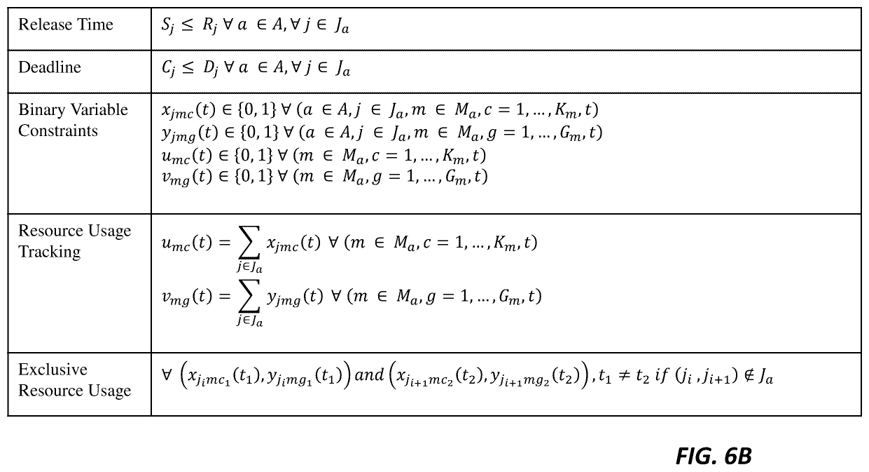

An algorithm implementing this example is shown with respect to the flow chart 700 of FIG. 7, which depicts the process flow for optimized workload management in heterogeneous computing environments. The diagram shows the decision-making process for allocating resources and executing applications with efficient sharing of accelerator resources.

The process begins at block 702 when an application is submitted to the job queue. At decision block 704, the system determines whether compiler-workload manager co-scheduling is enabled. This feature represents the bridge between compiler and workload manager that enables the resource sharing capabilities described in the disclosure. If co-scheduling is not enabled, the flow proceeds to block 706 where idle-nonsharing application execution occurs, following conventional scheduling approaches where resources are dedicated exclusively to applications.

If co-scheduling is enabled, the flow proceeds to block 708 where the system collects application metadata, e.g., data that was generated by the compiler. This includes the set of tasks Ja belonging to application a, the CPU cycle requirements Cⱼ^{CPU}, the GPU cycle requirements Cⱼ^{CPU}, release time rⱼ, deadline dⱼ, and task type tⱼ. The compiler generates one or multiple binaries for the application a based on target processor types.

At decision block 710, the system evaluates whether application a can be allocated to the available resources A. This evaluation applies the application assignment constraint from FIG. 6A, which ensures that each application is assigned to a set of machines (Mₐ⊆M).

If allocation is possible, the flow proceeds to block 712 where the system assigns application a to the subset of machines Mₐ. This assignment follows the job assignment constraints from FIG. 6A:

$$\sum {( t = {S}_{j} )}^{( Cj )} {x}_{jmc}^{t} = 1 ∀ a ∈ A , j ∈ {J}_{a}$$

$$\sum {( t = {S}_{j} )}^{( Cj )} {y}_{jmc}^{t} = 1 ∀ a ∈ A , j ∈ {J}_{a}$$

These equations ensure that each task is assigned appropriate CPU and GPU resources across time slots.

After assignment, at block 714, the system updates various parameters including start time Sⱼ, completion time Cⱼ, binary variables x_{jmc}^{t} (CPU assignment) and y_{jmg}^{t} (GPU assignment), and completion time slots for CPU execution Cⱼ^{CPU}, GPU execution Cⱼ^{GPU}, and tasks using both CPU and GPU Cⱼ^{Both}. These updates ensure compliance with the constraints outlined in FIGS. 6A and 6B, including precedence constraints, machine capacity, release time, and deadlines.

At block 716, the system executes application a on the assigned machines Mₐ and updates the resource usage tracking variables x_{jmc}^{t} and y_{jmg}^{t}. This execution follows the resource usage tracking constraints from FIG. 6B:

$${u}_{mc}^{t} \geq {x}_{jmc}^{t} ∀ j ∈ {J}_{a} , ∀ m ∈ M , c = 1 , … , {C}_{m} , t$$

$${v}_{mc}^{t} \geq {y}_{jmc}^{t} ∀ j ∈ {J}_{a} , ∀ m ∈ M , g = 1 , … , {G}_{m} , t$$

These constraints ensure proper tracking of resource usage across time slots.

Decision block 718 checks if application a has completed execution. If not, the process continues until completion. Once complete, the parameters from block 714 are again updated in block 720 and, upon completion, the flow returns to block 710 where the system again evaluates whether the application can be allocated to the available resources.

If application a cannot be allocated at decision block 710, the flow proceeds to decision block 722, which evaluates whether the application can be allocated with relaxed constraints that allow resource sharing. This evaluation considers the relaxed non-preemption constraints from the specification:

$${S}_{j} + {C}_{j}^{CPU} \leq {C}_{j} ∀ a ∈ A , j ∈ {J}_{a} , if job j uses only CPU$$

$${S}_{j} + {C}_{j}^{GPU} \leq {C}_{j} ∀ a ∈ A , j ∈ {J}_{a} , if job j uses only GPU$$

Sⱼ+max(Cⱼ^{CPU}, Cⱼ^{GPU})≤Cⱼ ∀ a∈A, j∈Jₐ, if job j uses both CPU and GPU

The relaxed exclusive resource usage constraint is also considered. If allocation with sharing is possible, the flow proceeds to block 724 where the system assigns application a to resources. This assignment considers the inter-application GPU sharing constrain, which allows GPU slots to be used by jobs from different applications during idle GPU cycles, ensuring efficient resource utilization.

After assignment, the process returns to block 714 to update parameters and continue execution. If allocation with sharing is not possible at decision block 722, the application remains in the job queue at block 718 where the execution can be completed.

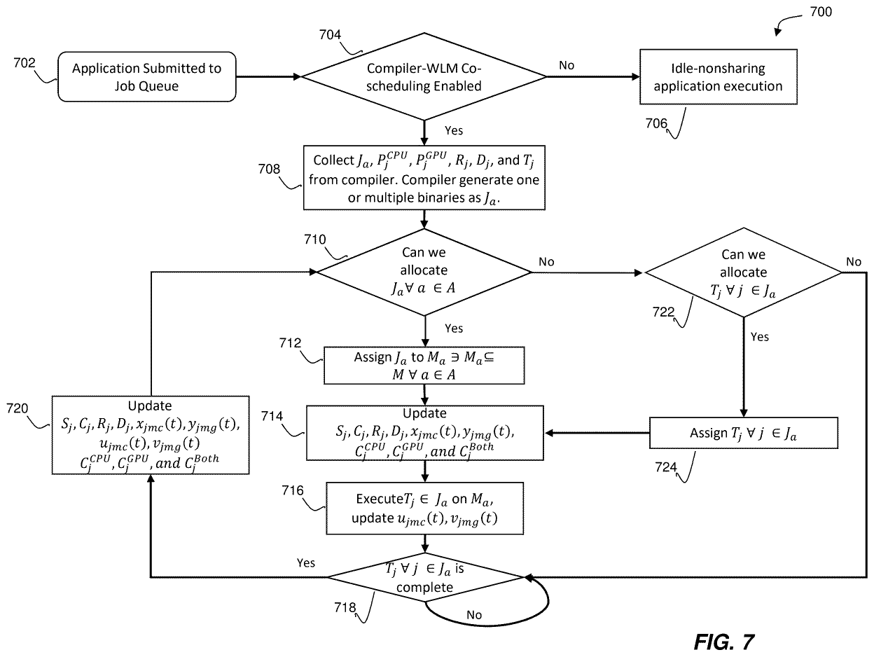

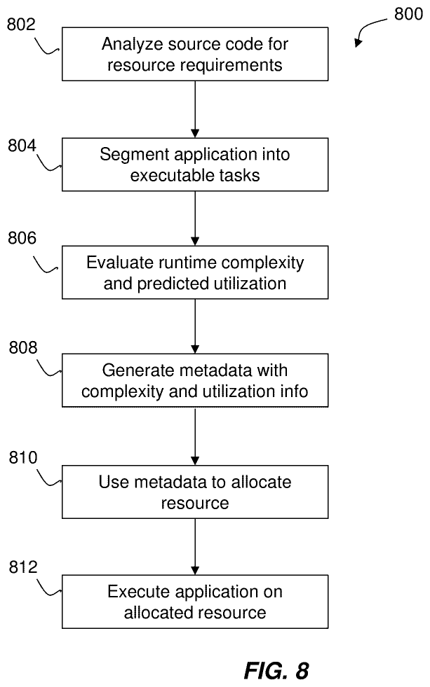

A more generalized application of the implementations can be explained with respect to the flow charts of FIGS. 8 and 9, which illustrate non-limiting examples of various implementations.

Referring first to FIG. 8, a computer-implemented method begins with analyzing source code of an application to identify portions that utilize different types of computing resources in block 802. In block 804, the application is segmented into a plurality of executable tasks based on target processor types. The target processor types include at least one of a central processing unit and an accelerator, e.g., GPU, QPU, FPGA. Over time, the segmentation can be adjusted based on feedback from previous executions of the application. The feedback, for example, can include actual resource utilization measurements compared to the predicted resource utilization patterns.

For each executable task, the runtime complexity is evaluated for execution on its target processor type and predicted resource utilization patterns for its target processor type (block 806). For example, the runtime complexity can be evaluated by determining a computational order of complexity for each executable task. The predicted resource utilization patterns can include a statistical distribution of expected resource usage over time.

In block 808, metadata is generated to associate the runtime complexity and the predicted resource utilization patterns with each executable task. This metadata can be used to allocate a resource for execution of at least part of the application (block 810) so that at least part of the application is executed using available time slots for the allocated resource that is concurrently executing another application (block 812).

In various implementations, the executable tasks and the metadata are packaged in a format accessible to a workload manager that uses the metadata to allocate the resource for the execution of the at least part of the application. The packaging can be performed by embedding the metadata in a non-executable section of application binaries for the application so that it can be extracted from the non-executable section prior to executing the part of the application. The metadata can be generated in a standardized format that is compatible with multiple different workload managers to enable the application to be scheduled across heterogeneous computing environments with different resource management systems.

In various implementations, the metadata includes information about data dependencies between executable tasks so that execution of the executable tasks can be ordered to minimize data transfer costs between different processor types. The gains achieved by sharing resources should not be lost by the costs of data transfers.

Another example of a computer-implemented method is illustrated by the flow diagram of FIG. 9. In block 902, resources of a first computing node are allocated to a first application that has been segmented into a plurality of executable tasks, e.g., as discussed with respect to FIG. 8 and elsewhere. Each executable task is associated with resource requirement data.

An executable task of the first application is executed at an accelerator of the first computing node in block 904. Resource requirement data can be embedded in a non-executable section of application binaries for the applications and extracted from the non-executable section prior to identifying the available compute cycle slots.

Based on the resource requirement data of the first application, available compute cycle slots of the accelerator are identified during execution of the executable task of the first application in block 906. The available compute cycle slots can be identified by determining time periods when the accelerator is not being fully utilized by the executable task of the first application based on predicted resource utilization patterns included in the resource requirement data of the first application and the second application.

In block 908, these available compute cycle slots of the accelerator are allocated to a second application based resource requirement data of the second application. For example, the resource requirement data might include runtime complexity and device utilization metrics for each executable task. Based on the resource requirement data of the first application and the second application, a job completion time improvement metric that can be generated to quantify expected performance gains from allocating the available compute cycle slots to the second application. The available compute cycle slots will be allocated only when the job completion time improvement metric exceeds a predetermined threshold.

An executable task of the second application can then be executed during the available compute cycle slots of the accelerator being used for execution of the executable task of the first application without degrading performance of the first application (block 910). The executable task of the first application and the executable task of the second application execute concurrently on the accelerator without preempting each other. The executable task of the application with the higher priority will, however, be given priority access to the accelerator if resource contention occurs.

In various implementations, data transfer costs associated with allocating the available compute cycle slots to the second application can be calculated before scheduling execution. The data transfer costs can be based on time required to move data to the accelerator and time required to retrieve results from the accelerator. A benefit of utilizing the available compute cycle slots would exceed the data transfer costs before allocating the available compute cycle slots to the second application.

In various implementations, a resource availability matrix is maintained to track availability of compute cycle slots for the accelerator across multiple time periods. This resource availability matrix can be updated as the executable task of the first application is executed and consulting when allocating the available compute cycle slots to the second application.

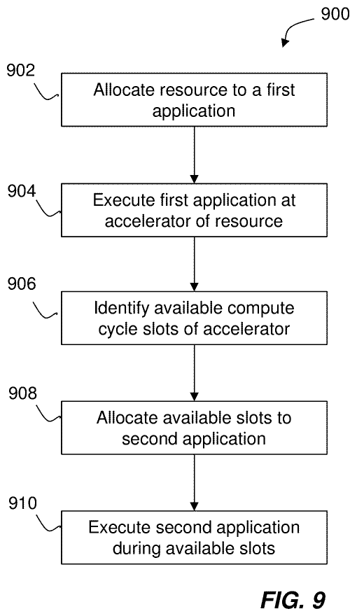

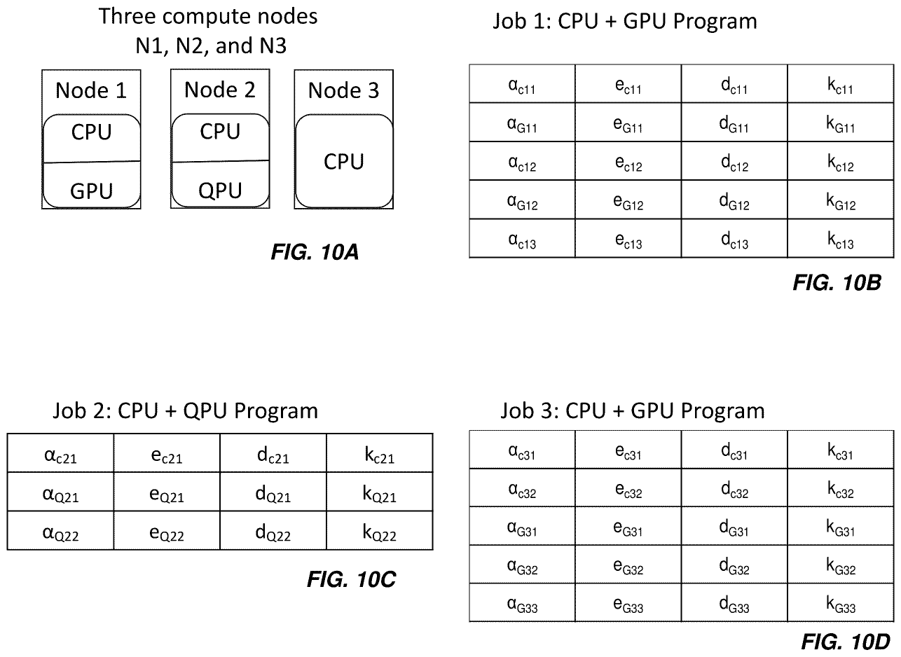

The operation of an example of the method will now be described with respect to a highly simplified example. FIG. 10A illustrates a heterogeneous computing environment comprising three compute nodes N1, N2, and N3, each with different hardware configurations. In this example, node N1 includes a CPU and a GPU, providing both general-purpose computing and specialized graphics processing capabilities. Node N2 is equipped with a CPU and a QPU, offering both classical and quantum computing capabilities. Node N3 contains only a CPU, providing general-purpose computing without specialized accelerators.

FIGS. 10B-10C depict three jobs that are to be executed using the compute nodes N1, N2, and N3. In this example, FIG. 10B depicts a first job that includes five tasks: three CPU tasks (denoted by α_{c11}, α_{c12}, and α_{c13}) and two GPU tasks (denoted by α_{G11} and α_{G12}). Each task is characterized by several parameters: α represents the arrival time, e denotes the execution time, d indicates the deadline, and k specifies the required compute cycles. For example, task α_{c11} has arrival time α_{c11}, execution time e_{c11}, deadline d_{c11}, and requires k_{c11} compute cycles on a CPU. Similarly, GPU task α_{G11} has its own set of parameters describing its resource requirements and timing constraints.

Similarly, FIG. 10C shows a second job, which is a CPU and QPU program consisting of three tasks: one CPU task (α_{c21}) and two QPU tasks (α_{Q21} and α_{Q22}). Each task is similarly characterized by its arrival time, execution time, deadline, and compute cycle requirements. This job specifically requires quantum processing capabilities, which are only available on node N2 in this environment.

FIG. 10D presents a third, which is another CPU and GPU program comprising five tasks: two CPU tasks (α_{c31} and α_{c32}) and three GPU tasks (α_{G31}, α_{G32}, and α_{G33}). Like the previous jobs, each task has its own set of timing and resource requirement parameters. This job requires both CPU and GPU resources for execution.

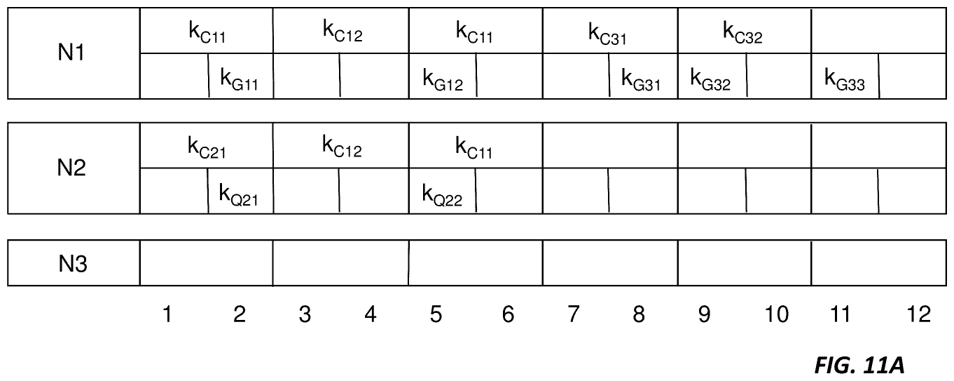

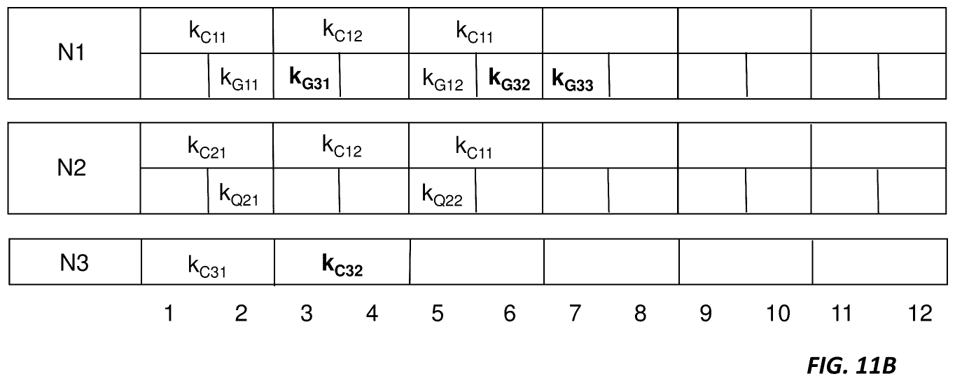

FIG. 11A provides a timing diagram illustrating an approach to resource allocation and job execution without resource sharing. In this scenario, jobs are allocated to nodes on a first-come, first-served basis with exclusive resource access. node N1 executes Job 1, utilizing its CPU for tasks k_{c11}, K_{c12}, and k_{c13} in sequence, and its GPU for tasks k_{G11} and k_{G12}. node N2 runs Job 2, with its CPU handling task k_{c21} and its QPU processing tasks k_{Q21} and k_{Q22}. In this traditional approach, Job 3 must wait for Job 1 to complete before it can access the GPU resources on node N1, as there is no mechanism for sharing the GPU between different jobs. Node N3 remains idle because none of the three jobs can be executed solely using a CPU.

FIG. 11B demonstrates a further optimized resource allocation approach enabled by implementing aspects of the invention, where accelerator resources can be shared across multiple jobs. In this scenario, Job 1 still executes on node N1 and Job 2 on node N2, but Job 3 can now begin execution without waiting for Job 1 to complete. The CPU tasks of Job 3 (k_{c31} and k_{c32}) are executed on node N3, while its GPU tasks (k_{G31}, k_{G32}, and k_{G33}) are interleaved with the GPU tasks of Job 1 on node N1. This interleaving occurs during periods when the GPU on node N1 would otherwise be idle while Job 1's CPU tasks are executing.

The example of FIG. 11B shows the benefit of having the ability to identify available compute cycle slots on accelerators and allocate them to tasks from different applications. By using the otherwise idle resource at node N3, three CPU time slots and five GPU time slots were made available upon completion of the three jobs. This optimization was made possible by the system's ability to segment applications into executable tasks based on target processor types, evaluate their runtime complexity and resource utilization patterns, and make intelligent scheduling decisions to efficiently utilize the accelerator while performing for all applications.

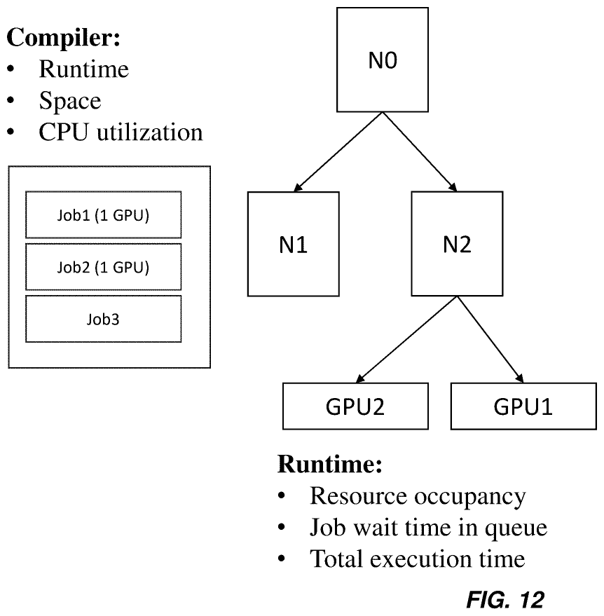

FIG. 12 illustrates the experimental setup used to verify the benefits of the invention in a real-world high-performance computing environment. The diagram depicts a test configuration comprising three nodes (N0, N1, and N2) with varying hardware capabilities, and three jobs (Job1, Job2, and Job3) that require execution within this environment.

Node N0 represents a management node that coordinates the workload management across the system. This node could host the workload manager components that implement the resource allocation and scheduling algorithms described in the invention.

Node N1 is a compute node equipped with standard CPU resources but no specialized accelerators. This node can execute general-purpose computing tasks that don't require accelerator support. Node N2 is a specialized compute node equipped with two GPUs (labeled GPU1 and GPU2). This node serves as a resource to provide the accelerator capabilities used multiple jobs. The limited availability of these GPU resources creates the potential bottleneck that can be addressed.

The experiment involves three jobs with different resource requirements: Job1 requires one GPU for execution, Job2 also requires one GPU for execution, and Job3 is a CPU-only job that doesn't require GPU resources. For simplicity, this experiment is limited to use of a single accelerator type. It is expected that similar results will be reached when more complicated networks that include different accelerator types are used.

The diagram also indicates the metrics used during the experiment. It is assumed that the metadata, e.g., provided from the compiler includes runtime complexity, space requirements, and CPU utilization metrics. The runtime environment will measure resource occupancy data, job wait time in the queue, and total execution time.

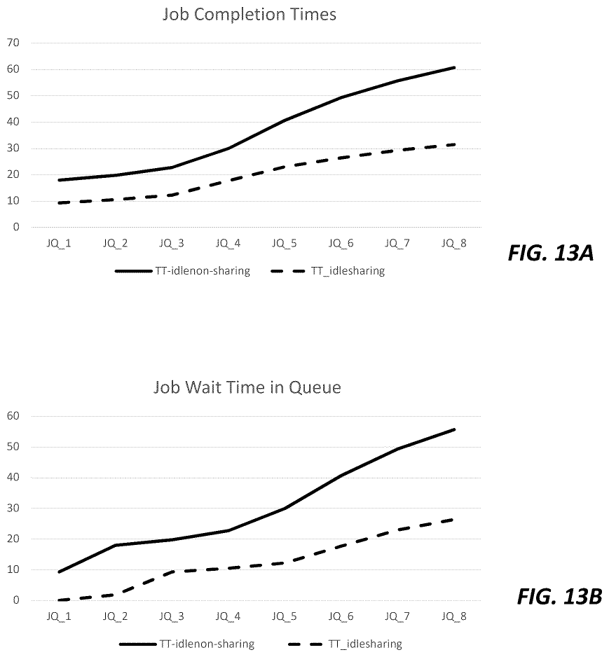

FIG. 13A presents the experimental results for job completion times, comparing the traditional non-sharing approach (labeled “TT_{idlenon-sharing}”) with the optimized resource-sharing approach (labeled “TT_{idlesharing}”). The horizontal axis (JQ_1 through JQ_8) represents different job queue configurations or test scenarios, while the vertical axis shows the job completion time in a standardized unit.

The graph clearly demonstrates that the resource-sharing approach consistently achieves shorter job completion times across all test scenarios. The performance gap between the two approaches widens as the job queue complexity increases (moving from JQ_1 to JQ_8), highlighting the scalability benefits of the invention. In the most complex scenario (JQ_8), the traditional approach results in completion times of approximately 60 time units, while the resource-sharing approach completes the same workload in about 32 time units, representing a reduction of nearly 47% in total execution time.

FIG. 13B presents the experimental results for job wait times in the queue, again comparing the traditional non-sharing approach with the optimized resource-sharing approach. The horizontal axis represents the same job queue configurations as in FIG. 13A, while the vertical axis shows the job wait time in the queue.

This graph demonstrates even more dramatic improvements in queue wait times. In the most complex scenario (JQ_8), jobs wait approximately 55 time units under the traditional approach, compared to only about 26 time units with the resource-sharing approach-a reduction of approximately 53% in wait time. This significant reduction in queue wait times directly translates to improved system responsiveness and user experience.

The results presented in FIGS. 13A and 13B provide compelling empirical evidence of the invention's benefits. By enabling intelligent sharing of accelerator resources across multiple applications, the system achieves substantial improvements in both job completion times and queue wait times. These improvements are particularly pronounced in complex scenarios with multiple jobs competing for limited accelerator resources, which is increasingly common in modern high-performance computing environments.

Although this disclosure describes or illustrates particular operations as occurring in a particular order, this disclosure contemplates the operations occurring in any suitable order. Moreover, this disclosure contemplates any suitable operations being repeated one or more times in any suitable order. Although this disclosure describes or illustrates particular operations as occurring in sequence, this disclosure contemplates any suitable operations occurring at substantially the same time, where appropriate. Any suitable operation or sequence of operations described or illustrated herein may be interrupted, suspended, or otherwise controlled by another process, such as an operating system or kernel, where appropriate. The acts can operate in an operating system environment or as stand-alone routines occupying all or a substantial part of the system processing.

While this disclosure has been described with reference to illustrative implementations, this description is not intended to be construed in a limiting sense. Various modifications and combinations of the illustrative implementations, as well as other implementations of the disclosure, will be apparent to persons skilled in the art upon reference to the description. It is therefore intended that the appended claims encompass any such modifications or implementations.

What is claimed is:

1. A computing system, comprising:
a workload manager comprising one or more processors and memory storing program code that, when executed by the one or more processors, causes the one or more processors to:
receive information related to a plurality of applications, each application segmented into executable tasks based on target processor types, wherein each executable task is associated with resource requirement data;
track compute cycle slot availability of an accelerator during execution of an executable task of a first application;
identify available compute cycle slots of the accelerator based the resource requirement data the executable task of the first application;
allocate the available compute cycle slots to executable tasks of a second application while maintaining execution of the first application; and
manage execution of the executable tasks of the second application during the available compute cycle slots.

2. The system of claim 1, wherein the accelerator comprises a graphics processing unit (GPU), a field-programmable gate array (FPGA), or a quantum processing unit (QPU).

3. The system of claim 1, further comprising a compiler comprising one or more processors and memory storing compiler program code that, when executed by the one or more processors of the compiler, causes the one or more processors to:
segment applications into pluralities of executable tasks based on target processor types;
evaluate runtime complexity and device utilization metrics for each executable task; and
for each executable task, associate the runtime complexity and device utilization metrics with the executable task.

4. The system of claim 1, wherein the accelerator includes multiple processing cores capable of executing different tasks simultaneously, and wherein the program code causes the one or more processors to assign executable tasks of the first application and the second application to different processing cores of the accelerator to enable parallel execution.

5. The system of claim 1, further comprising:
a plurality of computing nodes, wherein each of the computing nodes includes one or more processors and wherein one of the computing nodes includes a central processing unit and the accelerator; and
a high-speed interconnect between the computing nodes, wherein the program code causes the one or more processors to consider interconnect bandwidth and latency when allocating the available compute cycle slots.

6. A computer-implemented method comprising:
allocating resources of a first computing node to a first application that has been segmented into a plurality of executable tasks, each executable task being associated with resource requirement data;
executing an executable task of the first application at an accelerator of the first computing node;
identifying, based on the resource requirement data of the first application, available compute cycle slots of the accelerator during execution of the executable task of the first application;
allocating the available compute cycle slots of the accelerator to a second application, the available compute cycle slots being allocated based resource requirement data of the second application; and
executing an executable task of the second application during the available compute cycle slots of the accelerator being used for execution of the executable task of the first application.

7. The method of claim 6, wherein the resource requirement data includes runtime complexity and device utilization metrics for each executable task.

8. The method of claim 6, wherein identifying the available compute cycle slots comprises determining time periods when the accelerator is not being fully utilized by the executable task of the first application based on predicted resource utilization patterns included in the resource requirement data of the first application and the second application.

9. The method of claim 6, further comprising:
calculating data transfer costs associated with allocating the available compute cycle slots to the second application, wherein the data transfer costs are based on time required to move data to the accelerator and time required to retrieve results from the accelerator; and
determining that a benefit of utilizing the available compute cycle slots exceeds the data transfer costs before allocating the available compute cycle slots to the second application.

10. The method of claim 6, further comprising:
maintaining a resource availability matrix that tracks availability of compute cycle slots for the accelerator across multiple time periods;
dynamically updating the resource availability matrix as the executable task of the first application is executed; and
consulting the resource availability matrix when allocating the available compute cycle slots to the second application.

11. The method of claim 6, wherein the executable task of the first application and the executable task of the second application execute concurrently on the accelerator without preempting each other, and wherein the second application has a lower priority than the first application such that if resource contention occurs, the executable task of the first application is given priority access to the accelerator.

12. The method of claim 6, further comprising:
determining, based on the resource requirement data of the first application and the second application, a job completion time improvement metric that quantifies expected performance gains from allocating the available compute cycle slots to the second application; and
allocating the available compute cycle slots only when the job completion time improvement metric exceeds a predetermined threshold.

13. The method of claim 6, wherein the resource requirement data is embedded in a non-executable section of application binaries for the first and second applications, and wherein the method further comprises extracting the resource requirement data from the non-executable section prior to identifying the available compute cycle slots.

14. A computer-implemented method, comprising:
analyzing source code of an application to identify portions that utilize different types of computing resources;
segmenting the application into a plurality of executable tasks based on target processor types, wherein the target processor types include at least one of a central processing unit and an accelerator;
evaluating, for each executable task, runtime complexity for execution on its target processor type and predicted resource utilization patterns for its target processor type;
generating metadata that associates the runtime complexity and the predicted resource utilization patterns with each executable task;
using the metadata to allocate a resource for execution of at least part of the application; and
executing at least part of the application using available time slots for the allocated resource that is concurrently executing another application.

15. The method of claim 14, wherein generating the metadata comprises packaging the executable tasks and the metadata in a format accessible to a workload manager that uses the metadata to allocate the resource for the execution of the at least part of the application.

16. The method of claim 15, where the packaging comprises embedding the metadata in a non-executable section of application binaries for the application and the other application, and wherein the method further comprises extracting the metadata from the non-executable section prior to executing the at least part of the application.

17. The method of claim 14, wherein evaluating the runtime complexity comprises determining a computational order of complexity for each executable task and wherein the predicted resource utilization patterns include a statistical distribution of expected resource usage over time.

18. The method of claim 14, further comprising adjusting segmentation of the application based on feedback from previous executions of the application, wherein the feedback includes actual resource utilization measurements compared to the predicted resource utilization patterns.

19. The method of claim 14, wherein the metadata includes information about data dependencies between executable tasks, and wherein the method further comprises ordering execution of the executable tasks to minimize data transfer costs between different processor types.

20. The method of claim 14, wherein the metadata is generated in a standardized format that is compatible with multiple different workload managers to enable the application to be scheduled across heterogeneous computing environments with different resource management systems.
